(19) United States
(12) Patent Application Publication
(10) Pub. No.: US 2022/0010610 A1
(43) Pub. Date: Jan. 13, 2022

(54) INSULATED GLASS UNITS WITH LOW CTE CENTER PANES

(71) Applicant: CORNING INCORPORATED, CORNING, NY (US)

(72) Inventor: Michael Aaron McDonald, Painted Post, NY (US)

(21) Appl. No.: 17/296,357

(22) PCT Filed: Nov. 26, 2019
(86) PCT No.: PCT/US2019/063226

§ 371 Date: May 24, 2021

Related U.S. Application Data
(60) Provisional application No. 62/773,287, filed on Nov. 30, 2018.
(60) Provisional application No. 62/773,387, filed on Nov. 30, 2018.
(60) Provisional application No. 62/773,382, filed on Nov. 30, 2018.

(51) Int. Cl. E06B 3/67; B32B 17/10; C03C 27/10; E06B 3/663; E06B 3/673

(52) U.S. Cl. CPC E06B 3/6715; B32B 17/10055; C03C 27/10; E06B 3/67326; B32B 17/10119; E06B 3/66366; B32B 17/101

(57) ABSTRACT

An insulated glass unit includes a first pane, a second pane, and a third pane between the first and second panes, and a first sealed gap space between the first pane and the third pane and a second sealed gap space between the second pane and the third pane. The third pane comprises first glass sheet having a coefficient of thermal expansion (CTE) over a temperature range 0 to about 300° C. of less than about 70×10⁻⁷/° C.

### CROSS-REFERENCE TO RELATED APPLICATIONS

This application claims the benefit of priority under 35 U.S.C. § 119 of U.S. Provisional Application Nos. 62/773,287, 62/773,378 and 62/773,382, all filed Nov. 30, 2018, the content each of which are incorporated herein by reference in their entireties.

### FIELD OF THE DISCLOSURE

The disclosure herein relates generally to insulated glass units (IGUs) comprising two or more panes of glass having at least one pane, or a glass sheet component of at least one pane, that has a low coefficient of thermal expansion (CTE), e.g. less than about 70×10⁻⁷/° C. A low CTE center pane also allows for a thinner center pane, e.g. having a thickness of less than 0.9 mm. The disclosure also relates generally to insulated glass units (IGUs) comprising a laminated center pane comprising two low CTE glass sheets. The disclosure also relates generally to methods of manufacturing such IGUs, including those with one or more thin center panes, with at least one center pane including a low-emissivity (“low-E”) coating on at least one surface thereof.

### BACKGROUND

Insulated glass units (IGUs) are useful as components in a wide variety of applications, including architectural, automobile, display, and appliance components. IGUs can be used as multi-pane windows in buildings or in automobiles to provide insulative properties from external environmental temperatures. An IGU typically comprises two or more panes of glass sealed at their peripheral edges by a seal. The panes are spaced apart, and the space between each pane, once sealed, can be filled with an inert gas, such as argon or krypton, or an inert gas mixture. In doing so, the insulative or thermal performance of the IGU can be improved. However, full benefit of the sealed insulating gas layer is typically achieved with the addition of one or more low emissivity (“low-E”) coatings on one or more surfaces of the panes. The low-E coatings serve to reduce the transfer of heat energy, from pane to pane, by radiation and absorption of radiation.

In addition to thermal and insulative performance, an IGU typically meets other design constraints, including for example, weight, thickness, light transmittance, mechanical strength, and/or manufacturing cost.

Triple pane IGUs (e.g., three panes of glass with two air cavities) exhibit improved thermal and insulative performance as compared to double pane IGUs (e.g., two panes of glass with one air cavity), as indicated by an improvement of approximately 20-30% or more in solar heat gain coefficient (SHGC) and/or insulative U-values. However, triple pane IGUs can exhibit undesirable weight, thickness and/or manufacturing cost. Further, the additional weight, thickness, and/or manufacturing cost associated with the additional pane can adversely affect the IGU such that it does not meet design requirements for certain applications.

It has previously been proposed to reduce the center pane thickness. But, because the center pane is insulated on both sides, it can reach much higher temperatures and therefore higher stress levels than the inner- and outer-facing panes, such that it is typically required that the glass of the center pane is heat strengthened to improve its mechanical strength sufficiently to resist stresses produced by thermal gradients. To develop adequate strengthening through thermal strengthening of soda lime window glass, a sheet thickness of at least 1.5-2 mm is generally required, preventing the use of very thin (e.g., less than 1 mm) glass and the resultant advantages of such very thin glass.

As noted above, although a thin center pane is desirable for weight savings, thermal tempering processes encounter difficulties in providing sufficient strength, on thin sheets, to resist the thermal stresses that arise in the center pane of the IGU. Further, the necessary handling and manipulation to cut and install a very thin sheet of glass as the center pane or layer of an IGE can be difficult to perform/achieve. One approach to overcome these difficulties is to employ a very thin glass sheet which has been chemically strengthened. Chemical strengthening can ease the handling requirements and allow the sheet to withstand the thermal stresses produced as a center pane. However, in windows designs in which a center pane requires one side or both sides to have low-E coatings, manufacturability is potentially a problem with such chemically strengthened thin sheet glass. For example, a Low-E coating is most efficiently performed on large sheets, but low-E coated sheets cannot be chemically strengthened. Further, if chemical strengthening is used on a large sheet which is later cut to size for a window, then cutting the sheet, while possible, is often a somewhat sensitive and difficult process with possible breakage losses. Such an outcome is not conducive for large scale manufacturing. Further, much or all of the chemically-enhanced strength at the edge of the sheet can be lost by the cutting process. Thus, the handling benefits of strengthening may not be realized, and the resultant economics of manufacturing may not be particularly beneficial. Alternatively, cutting to size first, then strengthening, then coating is also economically unattractive as a manufacturing process, because of the need for custom, individual-piece coating and strengthening. Moreover, lowering the thickness of the center pane tends to lower the acoustic performance (the noise attenuation) of the IGU. Thus, the necessary handling and manipulation to cut and install a very thin sheet of glass as the center pane or layer of an IGE having the needed design and performance characteristics can be difficult to perform and achieve.

### SUMMARY

The present disclosure relates to an insulated glass unit comprising a first pane, a second pane, and a third pane between the first and second panes, and a first sealed gap space between the first pane and the third pane and a second sealed gap space between the second pane and the third pane. The third pane comprises a first glass sheet having a coefficient of thermal expansion (CTE) over a temperature range of 0 to about 300° C. of less than about 70×10⁻⁷/° C. The third pane can comprise first and second glass sheets laminated together with a polymer interlayer, and the first and second glass sheets exhibit a coefficient of thermal expansion (CTE) over a temperature range 0 to about 300° C. of less than about 70×10⁻⁷/° C.

According to another embodiment of the present disclosure, an insulate glass unit (“IGU”) is described comprising an insulated glass unit (1101) further comprising a first pane, a second pane, a third pane and a fourth pane disposed between the first and second panes. A first sealed gap space is defined between the first pane and the third pane. A second sealed gap space is defined between the third pane and the fourth pane and a third sealed gap space is defined between the second pane and the fourth pane. The third pane comprises a first glass sheet having a coefficient of thermal expansion (CTE) over a temperature range 0 to about 300° C. of less than about 70×10⁻⁷/° C. The third pane can comprise first and second glass sheets laminated together with a polymer interlayer, and the first and second glass sheets have a coefficient of thermal expansion (CTE) over a temperature range 0 to about 300° C. of less than about 70×10⁻⁷/° C. The fourth pane can likewise comprise first and second glass sheets laminated together with a polymer interlayer, with the first and second glass sheets having a coefficient of thermal expansion (CTE) over a temperature range 0 to about 300° C. of less than about 70×10⁻⁷/° C.

According to still another embodiment of the present disclosure, a method of making an insulated glass unit comprises cutting a selected size third pane from a larger glass sheet, the larger glass sheet having a coefficient of thermal expansion (CTE) over a temperature range 0 to about 300° C. of less than about 70×10⁻⁷/° C., then assembling the third pane with a first and a second pane, or with a first, a second, a third, and a fourth pane, to form an insulated glass unit having the third pane positioned between the first and second panes with a first a first sealed gap space defined on one side of the third pane and a second sealed gap space defined on the other side of the third pane.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and, together with the description, serve to explain the principles and operations of the disclosure.

### BRIEF DESCRIPTION OF THE DRAWINGS

The following detailed description can be further understood when read in conjunction with the following drawings in which:

FIG. 1 is a cross-sectional view of a three-pane IGU according to embodiments of the disclosure;

FIG. 2 is a cross-sectional view of a three-pane IGU according to embodiments of the disclosure;

FIG. 3 is a cross-sectional view of a four-pane IGU according to embodiments of the disclosure;

FIG. 4 is an illustration of a method of making an IGU according to embodiments of the disclosure;

FIG. 5 illustrates the max principle stress on a central layer of EAGLE XG® glass in a three-layer IGU at +60° C.;

FIG. 6 illustrates the deflection of a central layer of EAGLE XG® glass in a three-layer IGU at −40° C.;

FIG. 7 is a graph of deflection (sag) of a leading edge of a glass sheet, as a function of thickness, for a glass sheet being processed on a roller bed conveyor having a typical roller spacing;

FIG. 8 is a graph of deflection and stress of a glass sheet restrained at its edges under a cross-thickness thermal gradient, as a function of sheet thickness.

### DETAILED DESCRIPTION

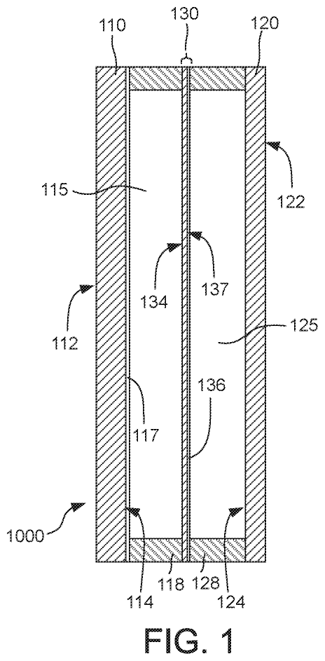

Various embodiments of the disclosure will now be discussed with reference to FIGS. 1-8, which illustrate exemplary embodiments of IGUs, and their components, features, or properties. The following general description is intended to provide an overview of the claimed devices, and various aspects will be more specifically discussed throughout the disclosure with reference to the non-limiting depicted embodiments, these embodiments being interchangeable with one another within the context of the disclosure.

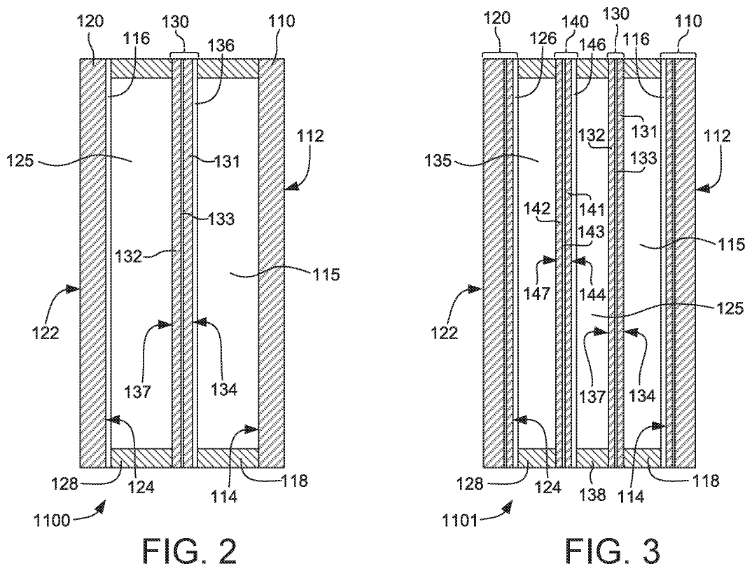

Disclosed herein are insulated glass units (IGUs) comprising a first pane, a second pane, and a third pane disposed between the first and second panes. One embodiment of an IGU 1000 is illustrated in the cross section of FIG. 1. Other embodiments are illustrated in the cross section of FIGS. 2 and 3. In some embodiments, the third pane comprises a glass laminate comprising two sheets of glass having an intermediate polymeric film. The one or more sheets of glass making up the center pane can have a coefficient of thermal expansion (CTE), over a temperature range 0 to about 300° C., of less than about 70×10⁻⁷/° C.

One embodiment of an IGU 1000 is illustrated in FIG. 1, the IGU comprising three panes 110, 120, and 130. A first (outer) pane 110 can be positioned such that its outer surface 112 faces the ambient external environment. A second (inner) pane 120 can be positioned such that its outer surface 122 faces the interior, e.g., inside a building, automobile, or appliance. A third (central) pane 130 can be disposed between and spaced apart from panes 110, 120. The third pane 130 can be positioned substantially parallel to the first and second panes 110, 120. Panes 110, 120, 130 can all be optically transparent, or one or more of the layers, or one or more portions or parts thereof can be semi-transparent, opaque, or semi-opaque. The third pane 130 comprises at least one glass sheet that has CTE over a temperature range 0 to about 300° C. of less than about 70×10⁻⁷/° C., alternatively less than about 50×10⁻⁷/° C., or alternatively less than about 35×10⁻⁷/° C. In some embodiments, as shown for example as IGU 1100 in FIG. 2, the third pane 130 comprises a glass laminate comprising first and second sheets of glass 131, 132 with an intermediate polymeric film or interlayer 133.

According to various embodiments, first and second panes 110, 120 can be thicker than third pane 130. In some embodiments, first pane 110 is thicker than third pane 130. In other embodiments, second pane 120 is thicker than third pane 130. In some embodiments, panes 110, 120 can have a thickness ranging from about 2 mm to about 16 mm, alternatively about 2 mm to about 10 mm, such as from about 3 mm to about 8 mm, alternatively from about 4 mm to about 7 mm, or alternatively from about 5 mm to about 6 mm, including all ranges and subranges therebetween. In a non-limiting embodiment, the first and second panes 110, 120 can comprise soda lime glass, although other glass types can be used without limitation, such as aluminosilicate and alkali aluminosilicate glasses, or other like glasses. The coefficient of thermal expansion (CTE) of the first and/or second pane 110, 120 can, in various embodiments, be greater than about 70×10⁻⁷/° C., such as greater than about 75×10⁻⁷/° C., alternatively greater than about 80×10⁻⁷/° C., alternatively greater than about 85×10⁻⁷/° C., alternatively greater than about 90×10⁻⁷/° C., greater than about 95×10⁻⁷/° C., or alternatively greater than about 10×10⁻⁶/° C., including all ranges and subranges therebetween, e.g., ranging from about 70×10⁻⁷/° C. to about 15×10⁻⁶/° C.

According to various embodiments, one or both the first and second panes 110, 120 can be strengthened, e.g., by thermal tempering, chemical strengthening, or other like processes, to improve the mechanical strength of one or both of these layers. The first and second panes 110, 120 can, in some embodiments, be produced by float or fusion draw manufacturing processes.

In certain embodiments of the disclosure, the inner surface 114 of the first pane 110 can be partially or fully coated with at least one first coating 117 (as shown in FIG. 1), such as low emissivity coatings for improving thermal performance. Low emissivity coatings are known in the art and can include, without limitation, sputter-coated and pyrolytic coatings comprising, for example, one or more metals and/or metal oxides such as silver, titanium, and fluorine-doped tin oxide, to name a few. Alternatively, or additionally, at least one of the major surfaces 134 (e.g. corresponds to first sheet 131, the gap 125 facing surface in the laminated version), 137 (e.g. corresponds to second sheet 132, the gap 115 facing surface in the laminated version) of the third pane 130 can be partially or fully coated with at least coating such as a low emissivity coating 136. Alternatively, or additionally, the inner surface 124 of second pane 120 can be partially or fully coated with at least one coating such as a low-emissivity coating 116 as shown in FIG. 2. The coatings can be the same or different depending upon the desired properties and/or end use of the IGU. Combinations of coatings can also be used. In various embodiments, one or more of the coatings can be optically transparent.

In non-limiting embodiments, third pane 130 can be thinner than first and second panes 110, 120. In some embodiments, the third pane 130 can have a total thickness of less than about 2 mm, such as from about 0.8 mm to less than about 2 mm, alternatively from about 0.9 mm to less than about 1.8 mm, alternatively from about 1 mm to less than about 1.7 mm, alternatively from about 1.1 mm to less than about 1.6 mm, or alternatively even to less than about 1.6 mm or alternatively even to less than about 1.5, about 1.4, about 1.2, or about 0.9 mm, including all ranges and subranges therebetween. According to still further aspects, the third pane 130 has a thickness of greater than about 0.4 mm, or alternatively greater than about 0.5 mm.

In a non-limiting embodiment, the third pane 130 can comprise a boro-silicate glass. In another a non-limiting embodiment, the third pane 130 can comprise a boro-aluminosilicate glass, such as an alkaline earth boro-aluminosilicate glass, or an alkali-free boro-aluminosilicate glass, or other similar glass types. Exemplary commercial glass products include, but are not limited to, Corning EAGLE XG®, and Lotus® glasses. The third pane 130 can, in some embodiments, be produced by float or fusion draw manufacturing processes.

According to various embodiments, the third pane 130 can have a lower CTE as compared to the CTE of the first pane 110 and/or second panes 120. As used herein, CTE refers to the coefficient of thermal expansion of an identified glass composition, or of a glass sheet or pane comprised thereof, as measured over a temperature range of 0 to about 300° C. In certain embodiments, the CTE of the third pane (CTE₃) can be less than about 70×10⁻⁷/° C., such as less than about 60×10⁻⁷/° C., alternatively less than about 50×10⁻⁷/° C., alternatively less than about 45×10⁻⁷/° C., alternatively less than about 40×10⁻⁷/° C., alternatively less than about 35×10⁻⁷/° C., alternatively less than about 30×10⁻⁷/° C., or alternatively even less than about 25×10⁻⁷/° C., including all ranges and subranges therebetween, e.g., ranging from about 10×10⁻⁷/° C. to about 70×10⁻⁷/° C. In additional embodiments, the CTE of the first pane (CTE₁) and/or the CTE of the second pane (CTE₂) can be greater than the CTE of the third pane (CTE₃), such as CTE₁>CTE₃ and/or CTE₂>CTE₃, or CTE₁≥2*CTE₃ and/or CTE₂≥2*CTE₃, or CTE₁≥2.5*CTE₃ and/or CTE₂≥2.5*CTE₃, or CTE₁≥3*CTE₃ and/or CTE₂≥3*CTE₃.

As mentioned, one or both major surfaces of third pane 130 can be partially or fully coated with at least one coating, such as the low emissivity coatings discussed above with respect to coatings 116, 117, 136. Alternatively, or additionally, one or both major surfaces of third pane 130 can be partially or fully patterned with ink and/or surface features, e.g., decorative ink, light scattering ink, and/or light scattering surface features. Bulk scattering features located within the glass matrix below the surface can also be provided in third pane 130, e.g., by laser patterning. Surface scattering features can also be produced by laser patterning. If a coating and/or pattern is provided on both major surfaces of third pane 130, these coatings and/or patterns can be the same or different depending upon the desired properties and/or end use of the IGU. Combinations of coatings and combinations of surface patterns can also be used. In additional embodiments, third pane 130 can comprise at least one coating and at least one of ink, surface features, and/or bulk features. Of course, the first and second panes 110, 120 can similarly be provided with such coatings, patterns, and/or features.

Referring again to FIG. 1, the third pane 130 and the outer pane 110 can be spaced apart and can define a first gap space 115 therebetween, and the third pane 130 and the second pane 120 can be spaced apart and can define a second gap space 125 therebetween. Both gap spaces 115, 125 can be hermetically sealed by a sealant assembly 118, 128, which can be unitary or in two parts, and if in two parts, can use identical or different parts. Exemplary sealant assemblies can be formed from polymeric-based seals or other sealing materials, such as silicone rubber. Gap spaces 115, 125 can be filled with inert gas. Suitable inert glasses include, but are not limited to, argon, krypton, xenon, and combinations thereof. Mixtures of inert gases or mixtures of one or more inert gases with air can also be used. Exemplary non-limiting inert gas mixtures include ratios of 90/10 or 95/5 argon/air, 95/5 krypton/air, or 22/66/12 argon/krypton/air mixtures. Other ratios of inert gases or inert gases and air can also be used depending on the desired thermal performance and/or end use of the IGU. According to various embodiments, the gas used to fill gap spaces 115, 125 can be the same or different.

The gas pressure in first gap space 115 and second gap space 125 can be the same or different. The gas pressure difference can, for example, be due to a difference in the average gas temperature in the two spaces, e.g., gas in first gap space 115 can be warmer than gas in second gap space 125, or vice versa, depending on the relative ambient and interior temperatures. Differential pressure between the two gap spaces 115, 125 can be sufficient to bend or bow the third pane 130, depending on the thickness of this layer. To prevent bowing, at least one channel or opening in third pane 130 can be provided in some embodiments to allow gas in gap space 115 to contact gas in gap space 125. Openings can be provided, for example, by drilling one or more orifices or holes into the third pane 130, or by providing a pressure relief path or channel through the sealant assembly 118, 128.

Referring now to FIG. 3, an alternative IGU 1101 is depicted, which comprises four panes 110, 120, 130, 140. The depicted embodiment is similar to that of FIGS. 1 and 2, except the IGU 1101 comprises an additional fourth (central) pane 140. The central panes 130, 140 are disposed between the first and second panes 110, 120.

In non-limiting embodiments, fourth pane 140 can be thinner than first and second panes 110, 120. In some embodiments, fourth pane 140 can be thinner than first and second panes 110, 120. In some embodiments, the fourth pane 140 can have a total thickness of less than about 2 mm, such as from about 0.8 mm to less than about 2 mm, alternatively from about 0.9 mm to less than about 1.8 mm, alternatively from about 1 mm to less than about 1.7 mm, alternatively from about 1.1 mm to less than about 1.6 mm, or alternatively even to less than about 1.6 mm or alternatively even to less than about 1.5, about 1.4, about 1.2 or about 0.9 mm, including all ranges and subranges therebetween. According to still further aspects, the fourth pane 140 has a thickness of greater than about 0.4 mm, or alternatively greater than about 0.5 mm. In some embodiments, the fourth pane 140 can be a glass laminate comprising first and second sheets of glass 141, 142 with an intermediate polymeric film or interlayer 143. The thickness of fourth pane 140 can be the same or different from the thickness of third pane 130.

In a non-limiting embodiment, the fourth pane 140 can comprise a boro-aluminosilicate glass, such as an alkaline earth boro-aluminosilicate glass, or an alkali-free boro-aluminosilicate glass, or other similar glass types. Exemplary commercial glass products include, but are not limited to, Corning EAGLE XG® and Lotus® glasses. According to various embodiments, fourth pane 140 can be strengthened, e.g., by thermal tempering, chemical strengthening, or other like processes, to improve the mechanical strength of this layer. The fourth pane 140 can, in some embodiments, be produced by float or fusion draw manufacturing processes. The composition of fourth pane 140 can be the same or different from the composition of third pane 130. The mechanical properties, e.g., degree of strengthening, of the fourth pane 140 can similarly be the same or different from the mechanical properties of the third pane 130.

According to various embodiments, the fourth pane 140 can have a lower CTE as compared to the CTE of the first and/or second panes 110, 120. In certain embodiments, the CTE of the fourth pane (CTE4) can be less than about 70×10⁻⁷/° C., such as less than about 60×10⁻⁷/° C., alternatively less than about 50×10⁻⁷/° C., alternatively less than about 45×10⁻⁷/° C., alternatively less than about 40×10⁻⁷/° C., alternatively less than about 35×10⁻⁷/° C., alternatively less than about 30×10⁻⁷/° C., or alternatively less than about 25×10⁻⁷/° C., including all ranges and subranges therebetween, e.g., ranging from about 10×10⁻⁷/° C. to about 70×10⁻⁷/° C. In additional embodiments, the CTE of the first pane (CTE₁) and/or the CTE of the second pane (CTE₂) can be greater than the CTE of the fourth pane (CTE₄), such as CTE₁>CTE₄ and/or CTE₂>CTE₄, or CTE₁≥2*CTE₄ and/or CTE₂≥2*CTE₄, or CTE₁≥2.5*CTE₄ and/or CTE₂≥2.5*CTE₄, or CTE₁≥3*CTE₄ and/or CTE₂≥3*CTE₄. CTE₃ and CTE₄ can be identical or different. According to non-limiting embodiments, CTE₃ is substantially equal to CTE₄.

Although not illustrated in FIG. 3, one or both major surfaces 134, 137 of third pane 130 and/or one or both major surfaces (144, 147) of fourth pane 140 can be partially or fully coated with at least one coating, such as the coating 146, which can be a low emissivity coating shown on major surface 144 of the fourth pane 140. Alternatively, or additionally, one or both major surfaces of third pane 130 and/or fourth pane 140 can be partially or fully patterned with ink and/or surface features, e.g., decorative ink, light scattering ink, and/or light scattering surface features. Bulk scattering features located within the glass matrix below the surface can also be provided in the third and/or fourth panes 130, 140 e.g., by laser patterning. Surface scattering features can also be produced using laser patterning. Coatings and/or surface patterns on one or both major surfaces of third and/or fourth panes 130, 140 can be the same or different depending upon the desired properties and/or end use of the IGU. Combinations of coatings and combinations of surface patterns can also be used. In additional embodiments, third and/or fourth panes 130, 140 can comprise at least one coating and at least one of ink, surface features, and/or bulk features.

Third pane 130 and the first pane 110 (e.g. outer pane) can be spaced apart and can define a first gap space 115 therebetween, third pane 130 and fourth pane 140 can be spaced apart and can define a second gap space 125 therebetween, and fourth pane 140 and second pane 120 (e.g. interior pane) can be spaced apart and can define a third gap space 135 therebetween. Gap spaces 115, 125, 135 can be hermetically sealed by a sealant assembly 118, 128, 138, which can be of one structure or of multiple pieces, with each identical or at least one different from the others. Exemplary sealant assemblies are disclosed above and exemplary inert gases and inert gas mixtures for filing the gap spaces are disclosed above with reference to FIG. 1. According to various embodiments, the gas used to fill gap spaces 115, 125, 135 can be the same or different.

Referring to FIGS. 1-3, the thickness of gap spaces 115, 125, 135 can vary depending on the IGU configuration and can range, for example, from about 6 mm to about 18 mm, such as from about 7 mm to about 16 mm, alternatively from about 8 mm to about 14 mm, or alternatively from about 10 mm to about 12 mm, including all ranges and subranges therebetween. The thickness of gap spaces 115, 125 (FIG. 2) or gap spaces 115, 125, 135 (FIG. 3) can be the same or different. A total thickness of the IGU 1000 or 1100 can be about 40 mm or less, such as about 36 mm or less, alternatively about 32 mm or less, alternatively about 30 mm or less, alternatively about 28 mm or less, or alternatively about 26 mm or less, including all ranges and subranges therebetween. In some embodiments, low U-values, indicative of improved insulative properties, can be obtained when the gap space thickness ranges from about 14 mm to about 16 mm and the total thickness of the IGU 1000 or 1100 ranges from about 36 mm to about 40 mm. A total thickness of the IGU 1101 can be about 60 mm or less, such as about 56 mm or less, alternatively about 54 mm or less, alternatively about 50 mm or less, alternatively about 40 mm or less, alternatively about 30 mm or less, or alternatively about 26 mm or less, including all ranges and subranges therebetween. In some embodiments, low U-values, indicative of improved insulative properties, can be obtained when the gap space thickness ranges from about 16 mm to about 18 mm and the total thickness of the IGU 1101 ranges from about 54 mm to about 60 mm.

It should be noted that while the first and second panes 110, 120 of FIGS. 1 and 2 are shown as single glass sheets, the claims appended herewith should not be so limited, as the panes can comprise a glass laminate structure such as shown in the panes 110, 120 of FIG. 3. Suitable glass-polymer laminate structures include can include a single sheet of glass laminated to a polymeric film, or, as shown, two sheets of glass having an intermediate polymeric film, and the like. In some embodiments, the laminates can comprise two or more panes, such as three or more panes, the panes being chosen from alkaline earth boro-aluminosilicate glass, alkali-free boro-aluminosilicate glass, and soda lime glass.

According to still further aspects of the present disclosure, the first pane 110 comprises a first polymer interlayer between the first glass sheet and the second glass sheet, wherein the first polymer interlayer is adhered to the first glass sheet and the second glass sheet. In some embodiments, the first polymer interlayer comprises a first polymer having a first elastic modulus and a second polymer having a second elastic modulus and wherein the first elastic modulus exceeds the second elastic modulus by at least about 20 times or more. Similarly, according to yet additional aspects, the second pane 120 comprises a third glass sheet and a fourth glass sheet and a second polymer interlayer between the third glass sheet and the fourth glass sheet, wherein the second polymer interlayer is adhered to the third glass sheet and the fourth glass sheet. In some embodiments, the second polymer interlayer comprises the first polymer and the second polymer. Again similarly, according to further additional aspects, the third pane 130 further comprises a fifth glass sheet 131 and a sixth glass sheet 132 and a third polymer interlayer 133 between the fifth glass sheet 131 and the sixth glass sheet 132, the third polymer interlayer 133 adhered to the fifth glass sheet 131 and the sixth glass sheet 132. In some embodiments, the third polymer interlayer 133 comprises the first polymer and the second polymer. Polymer interlayers having the first and second polymers help to reduce acoustic transmission.

The IGUs disclosed herein can be employed in various applications, and configured as products, including non-limiting examples of windows, doors, and skylights in buildings and other architectural applications, as windows in automobiles and other automotive applications, as windows or display panels in appliances, and as display panels in electronic devices, to name a few. According to various embodiments, one or more LEDs can be optically coupled to at least one edge of the IGU to provide illumination across one or more regions of the IGU. Edge lighting can, for instance, provide illumination that mimics sunlight, which can be useful in a variety of architectural and automotive applications, e.g., sky lights and sunroofs. As discussed above, one or more panes in the IGU can be provided with bulk or surface light scattering features, which can promote the uniformity of light transmitted by the IGU. Low CTE glass can, in some embodiments, be more easily laser processed to produce such light scattering features as compared to higher CTE glass, which often cracks or develops other defects during laser patterning.

In various non-limiting embodiments, using thin low CTE laminated glass for the center pane(s), e.g., the third and/or fourth panes, can provide several advantages over conventional IGUs. For example, a low CTE center pane can have improved resistance to thermal stresses and/or breakage caused by temperature gradients across the IGU, without requiring chemical or thermal strengthening. Manufacturing costs can thus be lowered by eliminating the thermal tempering or chemical strengthening step that would otherwise be used to strengthen a center pane comprising a conventional glass with a higher CTE.

Further, use of a laminated center pane as opposed to a single sheet of glass for the center pane can ease the physical handling requirements of the thin center pane and the fabrication handling requirements. Thus, in some embodiment of the present disclosure, the center pane may be comprised of sheets as thin as about 0.4 to about 0.7 mm, such that the laminated pane as a whole is still significantly thinner than even the thinnest conventional center panes. Use of the laminated center pane with polymer interlayer, particularly with an optional acoustic PVB polymer layer, improves acoustic dampening, which can help to offset reduction in sound attenuation otherwise produced by reducing the mass of the center pane.

Using a low CTE glass also enables a thinner pane to be economically provided with a low-E coating on one surface or both surfaces. Without the low CTE glass, strengthening would be needed to survive in the center pane location, and yet, thermal strengthening at <0.9 mm is difficult or not possible via conventional technology. Additionally, chemical strengthening is economically impractical because it is not compatible with pre-low-E-coated large sheets later cut to size, so the use of low CTE glass makes thin low-E coated sheets and panes comprising them realizable through the present technology described and claimed herein.

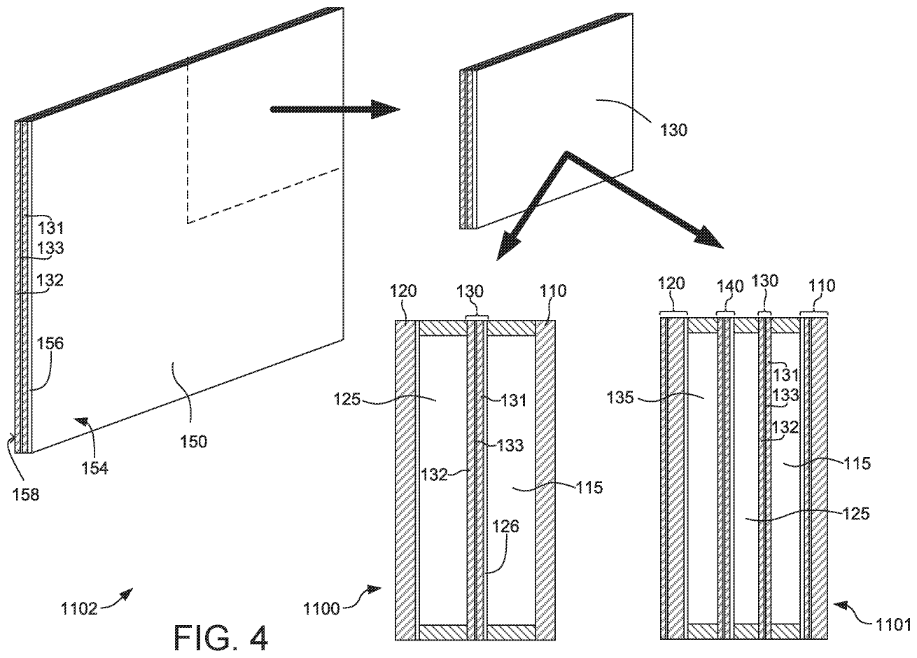

With reference to FIG. 4, in some aspects of the present disclosure, a method—illustrated as method 1102 of FIG. 4—is provided for making an IGU 1000, 1100, 1101. The method 1102 comprises cutting a selected size glass sheet 130 from a larger glass sheet 150, as indicated by the dashed line, for example. The larger glass sheet 150 has on a first major surface 154 and optionally on a second major surface 158 thereof a low-emissivity coating 156. The larger glass sheet 150 can have a CTE over a temperature range 0 to about 300° C. of less than about 70×10⁻⁷/° C. The larger glass sheet can have a thickness of less than about 2 mm, or even less than about 1.5, alternatively less than about 1.4, alternatively less than about 1.2, or alternatively less than about 0.9 mm. According to still further aspects, the third pane 130 has a thickness of greater than about 0.4 mm, or greater than about 0.5 mm. The method further comprises assembling the glass sheet 130 as a third pane 130 or as a component of a third pane 130 together with a first pane 110 and a second pane 120 (as in IGU 1000 or 1100, or together with a first pane 110, a second pane 120, and a fourth pane 140, (as in IGU 1101). The third pane 130 is assembled to be positioned between the first pane 110 and the second pane 120 with a first a first sealed gap space 115 positioned on one side of the third pane 130 and a second sealed gap space 125 positioned on the other side of the third pane 130. The larger glass sheet 150 can desirably have an even lower coefficient of thermal expansion (CTE) over a temperature range 0 to about 300° C. of less than about 50×10⁻⁷/° C., or alternatively of less than about 35×10⁻⁷/° C. The larger glass sheet 150 can also have a thickness of less than about 0.8 mm, or alternatively of less than about 0.6 mm. In a further aspect, the larger glass sheet 150 can desirably have a thickness of greater than about 0.4 mm, or alternatively of greater than about 0.5 mm.

According to another embodiment, a method for producing an IGU having a thin laminated center pane is shown in FIG. 4. The illustrated method 1102 of making an IGU (insulated glass unit) comprises cutting a selected size third pane 130 from a laminated sheet 150, as illustrated by the hashed lines in the figure. The laminated sheet 150 comprises first and second glass sheets 151, 152 laminated together with a polymer interlayer 153, with the first and second glass sheets having a CTE over a temperature range 0 to about 300° C. of less than about 70×10⁻⁷/° C. and a thickness of less than about 0.9 mm. The method further comprises assembling the third pane 130 with a first and a second pane 110, 120, or with a first a second and a fourth pane 110, 120, 140, to form an insulated glass unit 1100, 1101 having the third pane positioned between the first and second panes with a first a first sealed gap space 115 on one side of the third pane and a second sealed gap space 125 on the other side of the third pane. The thickness of the laminate sheet as a whole can be greater than about 0.8 mm, to allow the individual sheets 131, 132 to have thickness of about 0.4 mm or greater for ease of handling during lamination. The laminated sheet 150 can have a length and width dimensions at least larger than about 1.3× about 1.3 m, desirably larger than about 2× about 2 m. In another optional embodiment variation, at least one of the major surfaces 154, 158 of the laminated sheet can be coated with at least one coating 156 such as a low emissivity coating.

Because thermal tempering of a center pane can be avoided, the optical performance of the IGU can be improved, e.g., due to the lack of warp or birefringence caused by such a treatment step. The absence of a thermal tempering step can also allow for a thinner center pane, resulting in a reduced thickness and/or weight of the overall IGU. Reduced IGU weight can result in cost savings during manufacture, transport, installation, maintenance, and/or operation. Reduced IGU thickness can expand the range of applications for the IGU that might otherwise be limited by conventional design constraints.

A thinner low CTE center layer can also allow for wider sealed gap spaces between the panes. A larger volume of insulating gas in the sealed gap spaces can improve the energy efficiency of the IGU. IGUs with narrow sealed gap spaces can have an increased risk of bowing due to contraction of gas within the gap spaces, which can lead to contact between the outer panes and the center pane(s). Such contact is cosmetically undesirable and also permits direct conduction of heat between the panes, which can be unacceptable from an energy standpoint. Use of thinner low CTE center panes can provide wider gaps and therefore reduce the potential risk of bowing and/or contact between panes.

Thermal stress leading to glass breakage in the IGU can be caused, e.g., by rapid temperature changes of one region of the IGU relative to another region of the IGU. For instance, a rapid rise in external (ambient) temperature as compared to the interior temperature, or vice versa, can produce thermal stress on one or more regions of the IGU. For example, on a cold morning, sunlight incident on a window can rapidly raise the temperature of the regions of the IGU exposed to the sunlight, while the perimeter of the IGU, e.g., disposed under a window frame, remains cold. Finite element analysis (FEA) modeling shows that the resulting thermal stress on the center pane can reach about 0.62 MPa/° C. of temperature difference for traditional soda lime glass. Alternatively, in summertime conditions, (e.g., ˜28° C.), the center pane can reach temperatures as high as about 60° C., resulting in a temperature difference as great as about 40° C. between the center pane and the outer panes. The resulting thermal stress on a center layer comprising soda lime glass can thus be about 25 MPa or greater.

Soda lime glass has a CTE of approximately 90×10⁻⁷/° C. By comparison, while Corning® EAGLE XG® glass has a CTE of 31.7×10⁻⁷/° C., approximately ⅓ of the CTE of soda lime glass. Under the same 40° thermal gradient described above, a center layer comprising EAGLE XG® glass would experience 8.7 MPa of thermal stress, resulting in a lower risk of breakage, even without thermal tempering or chemical strengthening.

Modeling was carried out to evaluate the use of low CTE glass as a center pane between two higher CTE panes in an IGU. The model assumed a three-layer IGU (length=1265 mm, width=989 mm) with an outer pane comprising soda lime glass (thickness=4 mm), an inner pane comprising soda lime glass (thickness=6 mm), and a center pane comprising EAGLE XG® glass (thickness=0.7 mm). The gaps between the center pane and the inner and outer panes were 12 mm wide, filled with argon gas, and sealed with a silicone rubber perimeter seal.

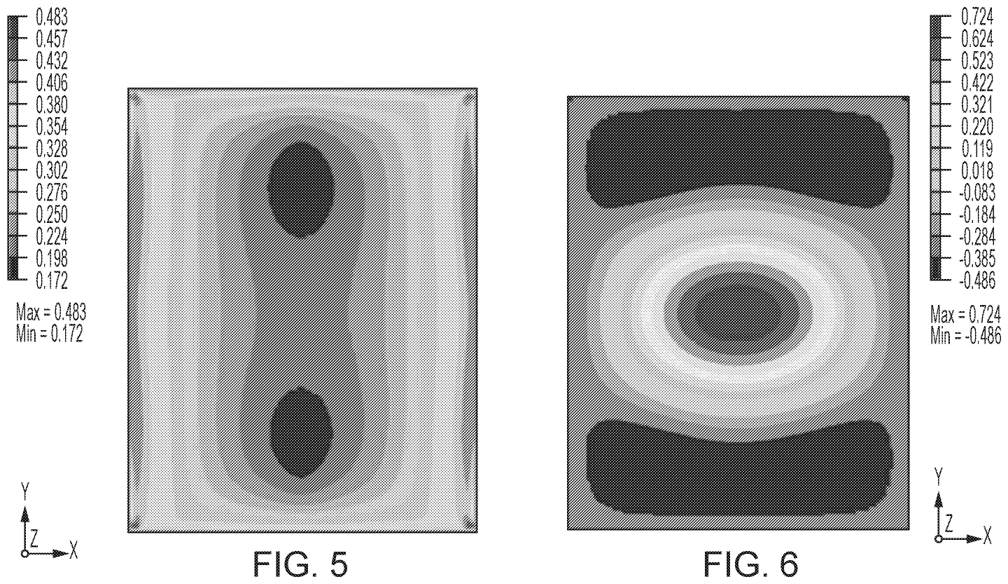

Referring to FIG. 5, tensile stress a low-CTE-glass third pane (using Corning EAGLE XG® as the low CTE glass) was modeled at +60° C. to simulate a scenario in which the soda lime panes expand due to elevated temperature. FIG. 6 is a model of compressive stress on the EAGLE XG® center pane at −40° C. to simulate a scenario in which the soda lime panes contract due to reduced temperature. FIG. 5 shows that the max principal stress on the EAGLE XG® center pane at +60° C. is less than 1 MPa, and FIG. 6 shows that deflection of the EAGLE XG® center pane is under 1 mm, indicating that the modeled (three pane) IGU can suitably withstand breakage, warping, and/or buckling due to thermal stresses induced by both high and low temperature gradients.

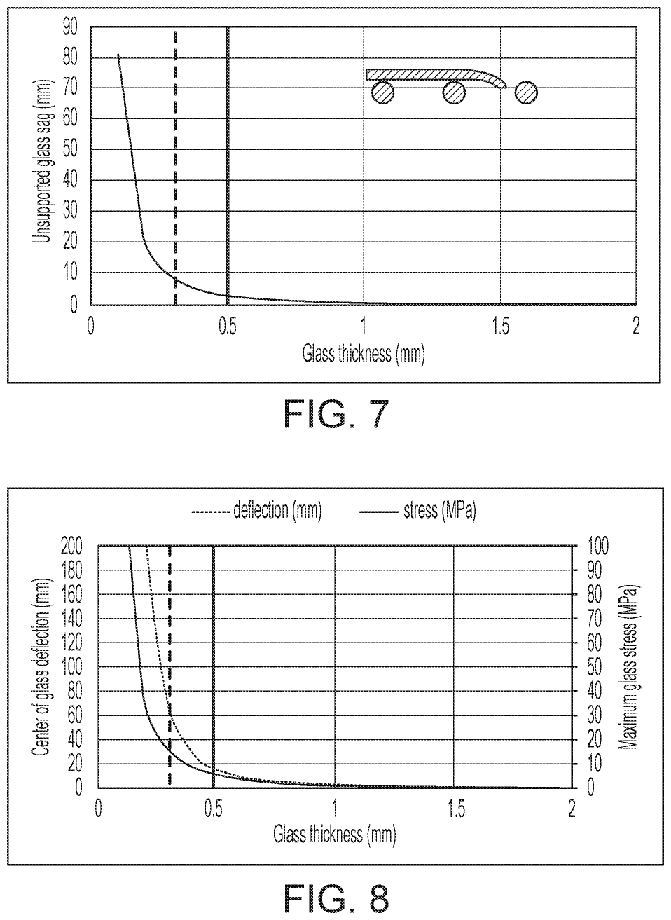

FIG. 7 is a graph of calculated deflection (sag) of a leading edge of a glass sheet, as a function of thickness, for a glass sheet being processed on a roller bed conveyor having a typical roller spacing such as used in conveying glass during low-E coating, for one example process. As may be seen in the figure, there is a dramatic difference in sag beginning at about 0.5 mm or about 0.4 mm and thinner. Accordingly, the larger sheet 150 and the resulting sheet 130 cut from it are desirably at least about 0.4 mm or greater in thickness or even about 0.5 mm or greater.

FIG. 8 is a graph of calculated deflection and stress of a glass sheet, restrained at its edges, under a cross-thickness thermal gradient such as might be present in a window under certain weather conditions, as a function of sheet thickness. Similarly, to the deflection shown in FIG. 7, a dramatic difference in thermally induced deflection appears at 0.5 mm or about 0.4 mm and below. Again for this reason, the larger sheet 150 and the resulting sheet 130 cut from it are desirably at least about 0.4 mm or greater in thickness or even about 0.5 mm or greater.

It will be appreciated that the various disclosed embodiments can involve particular features, elements or steps that are described in connection with that particular embodiment. It will also be appreciated that a particular feature, element or step, although described in relation to one particular embodiment, can be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a component” includes examples having one such “component” or two or more such “components” unless the context clearly indicates otherwise. Similarly, a “plurality” or an “array” is intended to denote two or more, such that an “array of components” or a “plurality of components” denotes two or more such components.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a dimension less than 100 nm” and “a dimension less than about 100 nm” both include embodiments of “a dimension less than about 100 nm” as well as “a dimension less than 100 nm.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments can be disclosed using the transitional phrase “comprising,” it is to be understood that alternative embodiments, including those that can be described using the transitional phrases “consisting” or “consisting essentially of,” are implied. Thus, for example, implied alternative embodiments to a device comprising A+B+C include embodiments where a device consists of A+B+C, and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure can occur to persons skilled in the art, the disclosure should be construed to include everything within the scope of the appended claims and their equivalents.

1. An insulated glass unit (1100) comprising:
a first pane (110);
a second pane (120);
a third pane (130) disposed between the first pane and the second pane;
a first sealed gap space (125) defined between the first pane and the third pane; and
a second sealed gap space (115) defined between the second pane and the third pane;
wherein the third pane comprises a first glass sheet (131) having a coefficient of thermal expansion (CTE) over a temperature range 0 to about 300° C. of less than about 70×10⁻⁷/° C.

2. The insulated glass unit of claim 1, wherein the third pane further comprises a second glass sheets (132) laminated to the first glass sheet (131) with a polymer interlayer (133), the second glass sheets having a coefficient of thermal expansion (CTE) over a temperature range 0 to about 300° C. of less than about 70×10⁻⁷/° C.

3. The insulated glass unit of claim 1, wherein one or both of the first and second glass sheets have a coefficient of thermal expansion (CTE) over a temperature range 0 to about 300° C. of less than about 50×10⁻⁷/° C.

4. The insulated glass unit of claim 1, wherein one or both of the first and second glass sheets have a coefficient of thermal expansion (CTE) over a temperature range 0 to about 300° C. of less than about 35×10⁻⁷/° C.

5. The insulated glass unit of claim 1, wherein the third pane comprises a boro-aluminosilicate glass.

6. The insulated glass unit of claim 5, wherein the third pane comprises an alkaline earth boro-aluminosilicate glass or an alkali-free boro-aluminosilicate glass.

7. The insulated glass unit of claim 1, wherein the third pane comprises float-formed glass.

8. The insulated glass unit of claim 1, wherein the third pane has a thickness of less than about 1.6 mm.

9. The insulated glass unit of claim 1, wherein the third pane has a thickness of less than about 0.9 mm.

10. The insulated glass unit of claim 1, wherein at least one of an inner surface (114) of the first pane, an inner surface (124) of the second pane, or at least one of the major surfaces (134, 137) of the third pane is coated with at least one low emissivity coating (116, 117, 136).

11. The insulated glass unit of claim 10, wherein at least one major surface of the third pane is coated with at least one low emissivity coating (136).

12. An insulated glass unit (1101) comprising:
a first pane (110);
a second pane (120);
a third pane (130); and
a fourth pane (140) disposed between the first pane and the second pane;
a first sealed gap space (115) defined between the first pane and the third pane; and
a second sealed gap space (125) defined between the third pane and the fourth pane;
a third sealed gap space (135) defined between the second pane and the fourth pane;
wherein the third pane comprises a first glass sheet (131) having a coefficient of thermal expansion (CTE) over a temperature range 0 to about 300° C. of less than about 70×10⁻⁷/° C.

13. The insulated glass unit of claim 12, wherein the third pane further comprises a second glass sheets (132) laminated to the first glass sheet (131) with a polymer interlayer (133), the second glass sheets having a coefficient of thermal expansion (CTE) over a temperature range 0 to about 300° C. of less than about 70×10⁻⁷/° C.

14. The insulated glass unit (1200) of claim 13, wherein the fourth pane comprises a first glass sheet (141) and a second glass sheet (142) laminated together with a polymer interlayer (143), the first glass sheet and the second glass sheet having a coefficient of thermal expansion (CTE) over a temperature range 0 to about 300° C. of less than about 70×10⁻⁷/° C.

15. The insulated glass unit of claim 14, wherein the first glass sheet and the second glass sheet of the third pane and the first glass sheet and the second glass sheet of the fourth pane each have a coefficient of thermal expansion (CTE) over a temperature range 0 to about 300° C. of less than about 35×10⁻⁷/° C.

16. The insulated glass unit of claim 15 wherein the third pane and the fourth pane each have a thickness of less than about 1.6 mm.

17. A method (1102) of making an insulated glass unit, the method comprising the steps of:
cutting a selected size glass sheet (130) from a larger glass sheet (150) having a first major surface (151) and a second major surface (152), the larger glass sheet (150) having a coefficient of thermal expansion (CTE) over a temperature range 0 to about 300° C. of less than about 70×10⁻⁷/° C. and a thickness of less than about 0.9 mm;
assembling the glass sheet as a third pane (130) or as a component of a third pane (130) together with a first pane (110) and a second pane (120), or together with a first pane (110), a second pane (120), and a fourth pane (140), to form an insulated glass unit (1000, 1100, 1101) having the third pane (130) positioned between the first pane (110) and the second pane (120) with a first a first sealed gap space (115) positioned on one side of the third pane (130) and a second sealed gap space (125) positioned on the other side of the third pane (130).

18. The method of claim 17, wherein the larger glass sheet (150) has coefficient of thermal expansion (CTE) over a temperature range 0 to about 300° C. of less than about 50×10⁻⁷/° C.

19. The method of claim 17, wherein the larger glass sheet (150) has coefficient of thermal expansion (CTE) over a temperature range 0 to about 300° C. of less than about 35×10⁻⁷/° C.

20. The method of claim 17, wherein the larger glass sheet (150) has a thickness of less than about 0.8 mm.

21. The method of claim 17, wherein the larger glass sheet (150) has a thickness of greater than about 0.4 mm.

22. The method according to claim 17 wherein the larger glass sheet is a laminated sheet comprising a first glass sheet (151) and a second glass sheets (151, 152) laminated together with a polymer interlayer (153).

23. The method according to claim 17 wherein the thickness of the third pane is greater than about 0.8 mm.

24. The method according to claim 23 wherein the laminated sheet has length and width dimensions larger than about 1.3× about 1.3 m.

25. The method according to claim 17 wherein at least one of the major surfaces of the larger sheet is coated with at least one low emissivity coating (156).

26. The method of claim 17, wherein the assembling step further comprises providing an architectural product.
